(19) United States
(12) Patent Application Publication
(10) Pub. No.: US 2005/0276885 A1
(43) Pub. Date: Dec. 15, 2005

(54) Self-venting microwaveable pouch, food item, and method of preparation

(76) Inventor: James A. Bennett, Yorba Linda, CA (US)

Correspondence Address: Bingham McCutchen LLP, Suite 1800, Three Embarcadero Center, San Francisco, CA, 94111-4067, US

(21) Appl. No.: 10/866,501

(22) Filed: Jun. 10, 2004

(51) Int. Cl. A23B 4/00

(52) U.S. Cl. 426/118

(57) ABSTRACT

A self-venting microwaveable pouch, a food product, and a method of preparing a food product utilizing a rupturable or vent seal that is formed in the pouch and along an aperture formed by the pouch. Multiple pouch products can be stored or displayed by placing hanger or hook through apertures defined by the pouch panels, such as apertures in the top sections of the panels. A vent seal is formed along the aperture. Flexible insets extend between bottom sections of the panels. The insets and bottoms of the panels and outwardly extendable to form a base to support the pouch in an upright position. In use, when a food item is heated in a microwave oven, the rupturable seal is reliably broken before other pouch seals. As a result, the pouch can be conveniently shipped and displayed, and the food item can be properly cooked and maintained within the container.

### FIELD OF THE INVENTION

The present invention relates to microwaveable containers, and more particularly, to a self-venting microwaveable pouch, having a seal that reliably breaks or ruptures before other pouch seals.

### DESCRIPTION OF RELATED ART

Various microwave cooking products and packages have been produced using different materials and venting mechanisms. For example, one common microwaveable cooking package is a microwave popcorn bag. Microwave popcorn bags are typically sealed and configured with a vent so that steam from heated popcorn kernels and oil can be released from the bag. The vent can also facilitate opening of the bag after the kernels have popped. Other microwaveable packages include food items that are divided within tray sections. The tray is typically covered by a plastic sheet or film. In use, a consumer partially lifts the plastic sheet from the tray or punctures the plastic covering to provide an outlet for steam that is generated by the heated food items. Other microwaveable containers, such as a pouch, utilize pre-formed slits or cuts to facilitate venting of the pouch.

Known microwaveable containers and pouches, can be improved. For example, they should be self-venting so that a consumer is not required to manually prepare or enable venting mechanisms. Further, they should vent reliably and predictably in a predetermined location to avoid undesirable pouch breaches. For example, edge seals of some conventional microwaveable pouches and bags may have consistent similar strength since they are sealed with a common sealing machine. As a result, when a pouch and a food item therein are heated in a microwave oven, accumulated steam from the heated food items can cause any one of the seals to randomly rupture, such as the side and/or bottom seals. In other words, various pouch seals can rupture in an unpredictable and uncontrollable manner. Consequently, the food item can inadvertently leak through the breaches in the pouch, resulting in a loss of the food item. Further, the food item remaining in the pouch may not be properly cooked, and the spilled food item can splatter onto interior surfaces of the microwave oven, requiring additional microwave cleaning by the consumer. Further, self-venting containers and pouches should be user friendly so that they can simply be inserted into the microwave without additional preparations. They should also be easy to display and store, such as on a hanger or other display stand.

### SUMMARY

In accordance with one embodiment, a self-venting pouch for use in heating a food item in a microwave oven includes a flexible front panel, a second flexible panel, and a rupturable seal formed in the panels. The panels are sealed together, thereby holding the food item therein. The rupturable seal is formed along an aperture defined by the panels. When the food item within the pouch is sufficiently heated in the microwave oven, the rupturable seal breaks to release steam from the heated food item.

In another embodiment, a microwaveable food product includes a self-venting pouch and a food item contained within the pouch. The pouch includes flexible panels that are sealed together. A rupturable seal is formed in the panels and along an aperture defined by the panels. When the food item within the pouch is sufficiently heated in the microwave oven, the rupturable seal breaks to release steam generated by the heated food item.

In yet a further embodiment, a method of preparing a food item in a microwave oven includes inserting the food item within a pouch having flexible panels that are sealed together, forming a rupturable seal that is formed along an aperture defined by the panels, inserting the pouch containing the food item in the microwave oven, heating the food item in the microwave oven, and breaking the rupturable seal to release steam generated by the heated food item.

In various embodiments, the panels can be sealed together using various techniques, e.g., a heat seal. The panels can also have various shapes, e.g., generally rectangular (as shown), square, or other sizes depending on the desired packaging and food product contained therein. For example, in one embodiment, the panels can have a width of about 3″ to about 5″ and a height of about 6″ to about 8″. Indeed, the configuration shown in the Figures is not intended to be limiting since other embodiments may utilize other pouch shapes and sizes.

The pouch can include flexible inset members that extend between the bottoms of the panel. The inset members and the bottoms of the panels can expand outward so that the bottoms of the panels form a base to enable the pouch to stand in an upright position. The panels can also define an indent so that the panels can be opened along a score or tear line defined initiated the indent.

The aperture defined by the panels can be defined through a top, middle or corner section of the panel with various shapes, e.g., circular, semi-circular, generally triangular shapes. The rupturable seal can be placed at various locations along the aperture, e.g., along a bottom, a side, and a bottom and a side of the aperture. The rupturable seal can have various suitable shapes and dimensions, e.g., a width of about 3 mm to about 10 mm along an aperture. The rupturable seal breaks before other panel seals to provide a reliable and predictable vent. For example, the vent seal may break after about 30 seconds to about 60 seconds of heating in a 1100 W microwave oven.

### BRIEF DESCRIPTION OF THE DRAWINGS

Referring now to the drawings, in which like reference numbers represent corresponding parts throughout, and in which:

FIG. 1 is a perspective view of an embodiment of a self-venting microwaveable pouch;

FIG. 2 is a front view of an embodiment of a self-venting microwaveable pouch;

FIG. 3 illustrates a self-venting pouch in an upright position in a microwave oven;

FIG. 4 illustrates a break in a rupturable seal due to accumulated steam in a pouch;

FIG. 5 is a side view of an embodiment of a self-venting microwaveable pouch;

FIG. 6 is a top view of an embodiment of a self-venting microwaveable pouch;

FIG. 7A is a bottom view of an embodiment of a self-venting microwaveable pouch illustrating flexible inset members extending between and bottom sections of the panels;

FIG. 7B is a bottom view of the pouch shown in FIG. 7A with the bottom sections of the panels and the inset members outwardly expanded to forma base or support;

FIG. 8 is a flow diagram illustrating a method of preparing a self-venting microwaveable pouch having a food item; and

FIG. 9 is a flow diagram illustrating a method of heating a food item contained within a self-venting pouch in a microwave oven.

### DETAILED DESCRIPTION OF EMBODIMENTS

Embodiments of a self-venting microwaveable pouch, a food product having a self-venting pouch and a food item, and methods for preparing and heating a food item in a microwave oven utilizing a self-venting pouch are disclosed. In the following description, reference is made to the accompanying drawings, which show by way of illustration specific embodiments. It is to be understood that other embodiments may be utilized.

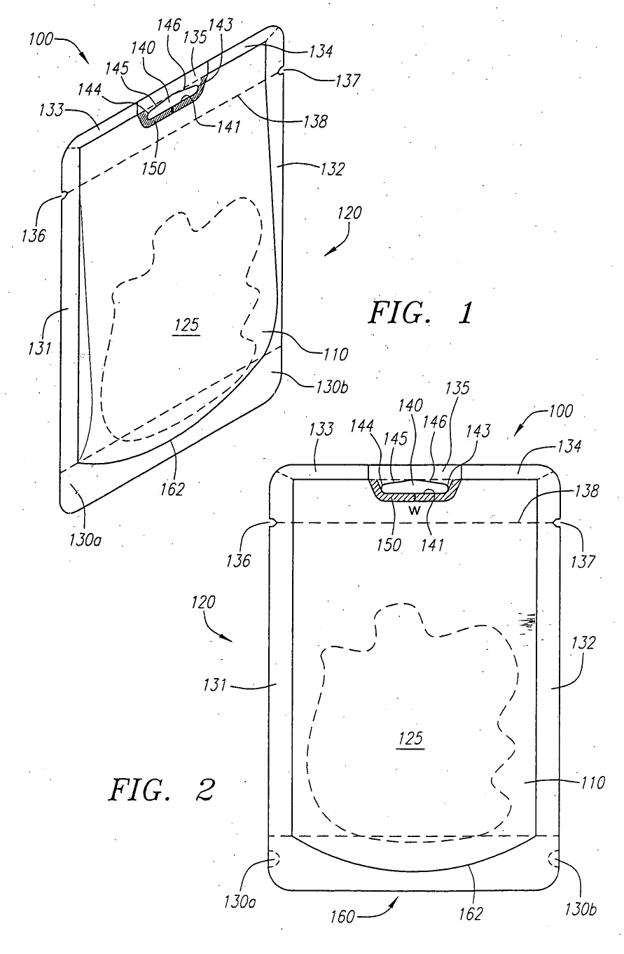

Referring to FIGS. 1 and 2, one embodiment of a self-venting microwavable pouch 100 includes a first or front panel, section or side (generally “panel”) 110 and a second or rear panel 120 (not shown in FIGS. 1 and 2). The panels 110 and 120 (generally 110) are sealed or secured together with a food item 125 there between. As illustrated, the panels 110 have a generally flat shape and similar sizes. The panels may be separate panels that are joined together. Alternatively, the panels 110 may be part of a uni-body or pre-formed construction. Thus, this specification refers to first and second “panels” as a reference to a side of the panel for purposes of explanation and illustration, not limitation.

The exemplary pouch panels 110 shown in FIGS. 1 and 2 are generally rectangular in shape and are approximately the same size. For example, the panels 110 can have a width of about 3″ to about 5″ and a height of about 6″ to about 8″. Indeed, other panel 110 configurations and dimensions, such as square and circular configurations, can also be utilized for different applications and food items 125. Thus, the rectangular configuration is illustrative of other shapes that can be utilized.

Exemplary food items 125 that can be contained within the pouch 100 include a sauce, a meat item, and meat, a combination of a and sauce food item. One exemplary food item 125 is commonly referred to as a Manwich® or “Sloppy Joe” food item, available from ConAgra Grocery Products Company, 3355 Michelson Drive, Irvine, Calif. Other suitable food items 125 include meat and meat-substitute items such as beef, pork, chicken, tuna, soy food items, tofu, vegetables, and combinations thereof. For purposes of explanation, not limitation, this specification refers to a combination meat and sauce food item, such as a Manwich® or “Sloppy Joe” food item.

The food item 125 can be inserted within the pouch 100 using various known food processing, sterilization, injection, vacuum and retort processing techniques. Accordingly, details of these known techniques are not discussed here in detail.

One or more or all of the exterior pouch surfaces can be laminated to provide further support to the pouch. Exemplary laminate materials include oriented polyester, oriented nylon or combinations thereof. Additional layers can be applied to these oriented polyester and/or nylon layers, to provide barrier or air tight properties to the pouch. These additional layers may include, for example, aluminum oxide and ethylene vinyl alcohol (EVOH). Further, the interior surfaces of the pouch can be prepared with suitable linings or coatings to facilitate heating, storage and processing of the food item. For example, the inner surfaces can laminated with a polypropylene layer or a polyethylene layer. Accordingly, embodiments are not limited to a particular manner of preparing a pouch 100 or pouch materials. Thus, various packaging techniques and materials can provide packaged food item 125 that has a long shelf life to provide extended distribution and storage durations and that can be stored in ambient, refrigerated or frozen conditions.

The panels 110 can be secured together using known heat, ultrasonic, and adhesive sealing techniques, as necessary. For example, with the exemplary rectangular panel configuration, the panels 110 are secured together with side or lateral seals 131 and 132, and one or more top seals or seal sections 133 and 134. If necessary, the top sections of the panels 110 can also be sealed together with a top middle seal section 135. Persons of ordinary skill in the art will recognize that various other seal and seal section configurations can be utilized. Persons of ordinary skill in the art will also appreciate that a sealing device can be configured to provide a single seal or multiple seals to cover the seal sections, however, the seals are illustrated as bottom, top and side sections for purposes of illustration.

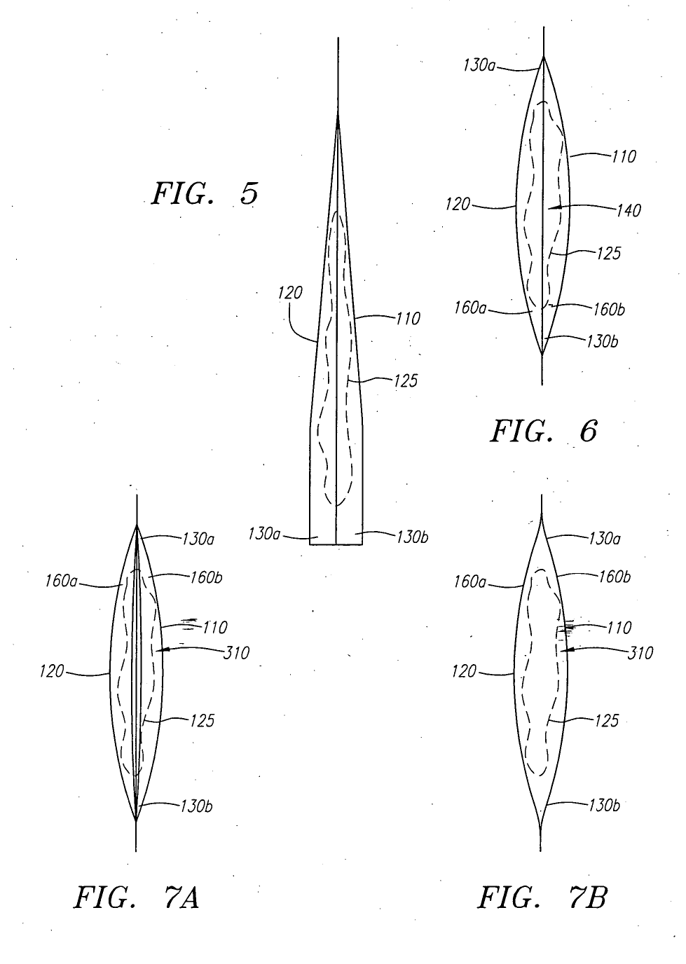

As shown in FIGS. 2, 5, 7A and 7B, flexible inset members 160a-b (generally 160) extend between bottom sections of panels 110 and upward into the pocket or pouch interior where they meet at 162. As shown in FIGS. 1 and 2, line 162 can have a contour shape to form a “pocket” for holding the food item. Indeed, other shapes can be utilized. The ends of the bottoms of panels 110 are sealed with end seals 130a-b (generally 130). Thus, the mid-sections of the bottoms of the panels 110 are not sealed together and are moveable. As a result, the base members 160 and bottoms of panels 110 can freely expand outward (FIG. 7B).

An aperture or slot 140 is formed through the panels 110. The aperture 140 can have a shape, such as a rectangular or triangular shape, so that the pouch 100 or multiple pouches can be placed on a hanger or other store display. Indeed, other aperture 140 shapes and sizes may be utilized depending on the particular pouch configuration and display or storage application. For example, other suitable aperture 140 shapes may be circular, elliptical and vertical and horizontal slot shapes. Additionally, although the aperture 140 is shown in FIGS. 1 and 2 as being located in the middle of the top sections of the panels 110, other suitable aperture locations may include corners and sides of the panels 110. Additionally, the aperture may be formed by removing panel material or by cutting or scoring material that is not completely removed to form a flap.

A rupturable or vent seal 150 is formed in the panels 110 and along the aperture 140. Various vent seal 150 configurations may be suitable depending on the shape and location of the aperture 140. In one embodiment, as shown in FIGS. 1 and 2, the vent seal 150 generally follows the bottom 141 and sides 142 and 143 of an aperture 140. In this embodiment, the width W of the seal 150 can range from about 3 mm to about 10 mm. Indeed, different vent seal 150 configurations and dimensions can be used with different aperture 140 shapes and sizes.

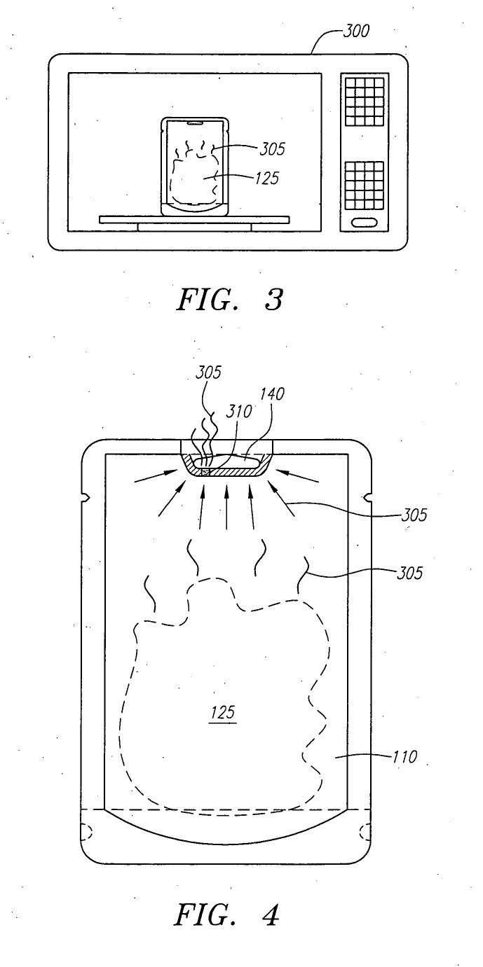

In use, referring to FIGS. 3 and 4, a pouch 100 with a food item 125 is placed in a microwave oven 300 and heated. As the food item 125 is heated, it releases steam 305, which accumulates within the pouch 100. Before the seal 150 is broken, the accumulated steam 305 can further cook the food item 125 in conjunction with microwave energy. As the steam 305 continues to accumulate within the pouch. 100, the resulting forces generally (shown by arrows) are higher on the vent seal 150 due to the pouch geometry. Since the smaller area seal 150 has a larger concentration of steam 305 forces compared to longer bottom, side and top seals 130-134.

The steam 305 forces eventually form a breach or break 310 in the rupturable seal 150, preferably before one of the other bottom, top or side seals 130-134 break in this embodiment. With this configuration, the seal 150 predictably and reliably breaks somewhere along the aperture, before the other pouch seals, thereby maintaining the integrity of the bottom and side pouch seals 130-132. Further, once the seal 150 has broken, the integrity of the bottom and side seals 130-132 is maintained since steam 300 is released through the seal break 310.

For example, in one implementation, a pouch 100 was prepared with a Manwich® type product having a meat and a sauce. The panel seals 130-134 and the rupturable or vent seal 150 were prepared using known heat seal techniques. The filled and sealed pouch 100 was placed in a 1100 W microwave 300 and heated for about 30 to about 60 seconds. The seal 150 ruptured, thereby releasing steam 305 from the pouch 100 through the break 310. Persons of ordinary skill in the art will recognize that other food items 125 having different moisture contents may generate different amounts of steam 305, which in turn, can alter the vent, real configuration and the duration of microwave 300 heating that is required to rupture the vent seal 150. For example, foods with a higher fat content may be heated more quickly than foods with lower fat contents.

Persons of ordinary skill in the art will also appreciate that while the vent seal 150 predictably and reliably fails before the bottom and side pouch seals, different sections and lengths of the vent seal 150 can break. A seal break 310 can occur along the entire vent seal 150 or portions thereof. For example, a break 310 can occur at one of the ends of the vent seal, e.g., at the ends 143 and 144 of the aperture 140. A break 310 can also occur at middle section of the vent seal, e.g., at the bottom 141 of the aperture 140. Alternatively, a break 310 can occur at side and a middle section of the seal 150.

After the food item 125 is prepared and the seal 150 has been broken, the pouch 100 can be opened to access the food item 125 therein. For example, in one embodiment, one or more sides or edges of the panels 110 define one or more score line or tear indents 136 and 137 (generally 136). As shown in FIGS. 1-3, the indents 136 are located towards the top of the pouch 100 and generally define a tear line 138 along a top section of the panels 110. In the illustrated embodiment, the tear line 138 is below the seal 150 and the aperture 140. In use, after the food item 125 is prepared in a microwave oven, a user applies force above and below the indent 136 to tear the panels 1.10 to access the heated food item 125.

Referring to FIGS. 7A-B, the bottoms of the pouch panels 110 and 120 are flexible inset members 160 can be expanded outward as needed to form a base or a support. The outwardly extending bottom section of the panels 110 and 120 form a base that allows the pouch 100 to stand in a stable, upright position (FIG. 3). In the illustrated embodiment, the seal 150 is positioned at the top of the pouch 100. This configuration allows a consumer to simply place the food-filled pouch in the microwave oven in an upright position without worrying about the pouch filling over or a side or bottom pouch seal breaking.

In various embodiments, the food item 125 may be stored throughout the entire interior or pocket of the pouch 100 or portions thereof when in storage or when not heated, for example, depending on the orientation of the pouch and the particular food item (e.g. liquid, semi-solid solid) food items. Thus, the weight of the food item 125 within the bottom portion of the pouch 100 and the resulting low center of gravity provide further support to a vertically oriented pouch. When an upright or standing is heated, the food item 125 may totally or partially liquefy and settle towards the bottom of the pouch 100. Further, when a user opens the pouch using along the tear line 138, the heated food item 125 remains within the bottom of the pouch 100 and does not leak from the opened top section.

Having described embodiments of a self-venting microwaveable pouch and a food product according to the present invention, this specification now describes methods of preparing and heating a food item using a pouch having a rupturable vent seal as previously discussed.

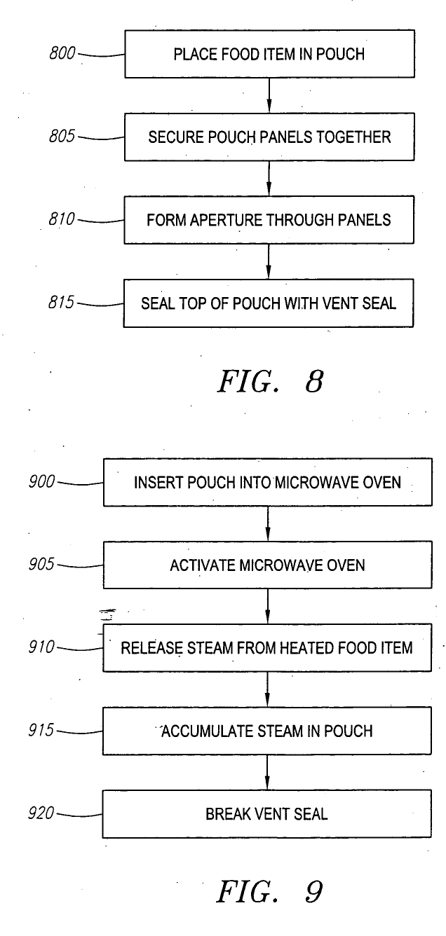

Referring to FIG. 8, in step 800, a food item is placed or injected within a pouch having flexible front and back panels using, for example, known retort processing or other sterilization techniques. In step 805, the panels are secured or sealed together so that the food item is contained within the pouch between the panels. In step 810, an aperture is formed within the panels. The aperture can be used to hang the pouch from a display stand. In step 815, the top of the pouch is sealed with a vent seal that is formed along the aperture. Persons of ordinary skill in the art will recognize that these steps can be performed in different orders. For example, the aperture formation can be done before filling. Further, a pouch can be filled with a food item after most of the seals have been made.

Referring to FIG. 9, in use, in step 900, the pouch containing the food item is inserted into the microwave oven. In step 905, the microwave oven is activated to heat the food item. In step 910, the heated food item releases steam, which can also cook the food item in addition to the microwave heating. In step 915, the steam accumulates within the pouch until sufficient pressure builds within the pouch so that in step 920, the rupturable seal breaks and releases the steam from the pouch.

Persons of ordinary skill in the art will recognize that the inventive concepts and embodiments described herein can be utilized with different panel, aperture, and rupturable vent seal configurations and different food items and products. For example, various configurations and sizes pouch panels can be utilized. Further, various sizes and shapes of apertures and vent seals can be utilized. Further, although this specification refers to a meat and sauce product, other food items can be prepared with the present invention including, but not limited to, various sauces to be added to a food item (e.g., marinara, meat, and alfredo sauces), meat (e.g., beef, chicken, pork and tuna) and meat substitute products (soy-based products and tofu), and vegetables. Accordingly, persons of ordinary skill in the art will appreciate that the invention is not limited to the particular exemplary embodiments described and illustrated, but that insubstantial modifications, alterations, and substitutions can be made to the described embodiments without departing from the scope of the invention, as recited in the accompanying claims.

1. A self-venting pouch for use in heating a food item in a microwave oven, comprising:
a first flexible panel;
a second flexible panel, the first and second panels being sealed together with the food item therein; and
a rupturable seal formed in the first and second panels and along at least a portion of an aperture defined by the panels,
wherein at least a portion of the rupturable seal breaks to release steam generated by the heated food item within the pouch when the food item is sufficiently heated in the microwave oven.

2. The pouch of claim 1, the first and second panels being generally rectangular.

3. The pouch of claim 1, the first and second panels being approximately the same size.

4. The pouch of claim 1, the first and second panels having a width of about 3″ to about 5″ and a height of about 6″ to about 8″.

5. The pouch of claim 1, the first and second panels being substantially flat.

6. The pouch of claim 1, a side of the first and second panels defining an indent or a score line, wherein the pouch can be opened by tearing the first and second panels at the indent or the score line.

7. The pouch of claim 1, the first and second panels being torn below the aperture.

8. The pouch of claim 1, the first and second panels being sealed together with a heat seal.

9. The pouch of claim 1, the first and second panels being sealed together above the aperture.

10. The pouch of claim 1, the rupturable seal being formed in a top of the pouch.

11. The pouch of claim 1, the first and second panels defining an aperture in a top of the panels.

12. The pouch of claim 1, the first and second panels defining an aperture having a shape to allow the pouch to be hung or displayed.

13. The pouch of claim 1, the rupturable seal being formed in the panels and along a bottom of the aperture.

14. The pouch of claim 1, the rupturable seal being formed in the panels and along a side of the aperture.

15. The pouch of claim 1, the rupturable seal having a contoured shape.

16. The pouch of claim 1, wherein the rupturable seal breaks before other panel seals.

17. The pouch of claim 1, wherein the rupturable seal breaks after about 30 seconds to about 60 seconds of heating in a 1100 W microwave oven.

18. The pouch of claim 1, wherein the entire rupturable seal breaks.

19. The pouch of claim 1, further comprising a plurality of flexible inset members, the inset members extending between the bottoms of the first and second panels and upward into the pouch interior.

20. The pouch of claim 19, the inset members and the first and second panels being outwardly expandable so that the bottoms of the panels form a base to support the pouch in an upright position.

21. The pouch of claim 19, the tops of the first and second members being sealed together.

22. The pouch of claim 19, the sides of the first and second panels being sealed together.

23. The pouch of claim 19, the ends of the bottoms of the first and second panels being sealed together.

24. A food product that is prepared in a microwave oven, comprising:
a self-venting microwaveable pouch, the pouch having:
a first flexible panel,
a second flexible panel, the first and second panels being sealed together to form the pouch, and
a rupturable seal formed in the panels and along at least apportion of an aperture defined by the first and second panels; and
a food item contained within the pouch,
wherein at least a portion of the rupturable seal is broken to release steam generated by the heated food item within the pouch when the food item is sufficiently heated in the microwave oven.

25. The product of claim 24, the first and second panels being generally rectangular.

26. The product of claim 24, the first and second panels being approximately the same size.

27. The product of claim 24, the first and second panels having a width of about 3″ to about 5″ and a height of about 6″ to about 8″.

28. The product of claim 24, the first and second panels being substantially flat.

29. The product of claim 28, a side of the first and second panels defining an indent or a score line, wherein the pouch can be opened by tearing the first and second panels at the indent on the score line.

30. The product of claim 24, the first and second panels being torn below the aperture.

31. The product of claim 24, the first and second panels being sealed together with a heat seal.

32. The product of claim 24, the first and second panels being sealed together above the aperture.

33. The product of claim 24, the rupturable seal being formed in a top of the pouch.

34. The product of claim 24, the first and second panels defining the aperture in a top of the panels.

35. The product of claim 24, the first and second panels defining the aperture in a side of the panels.

36. The product of claim 24, the first and second panels defining the aperture in a corner of the panels.

37. The product of claim 24, the first and second panels defining an aperture having a shape to allow the pouch to be hung or displayed.

38. The product of claim 24, the rupturable seal being formed in the panels and along a bottom of the aperture.

39. The product of claim 24, the rupturable seal being formed in the panels and along a side of the aperture.

40. The product of claim 24, wherein the rupturable seal breaks before other panel seals.

41. The product of claim 24, wherein the rupturable seal breaks after about 30 seconds to about 60 seconds of heating in a 1100 W microwave oven.

42. The product of claim 24, wherein the entire rupturable seal breaks.

43. The product of claim 24, further comprising a plurality of flexible inset members, the inset members extending between the bottom sections of the first and second panels and upward into the pouch interior.

44. The product of claim 32, the inset members and the first and second panels being outwardly expandable so that the bottoms of the panels form a base to support the pouch in an upright position.

45. The product of claim 32, the tops of the first and second panels being sealed together.

46. The product of claim 32, the sides of the first and second panels being sealed together.

47. The product of claim 32, the ends of the bottoms of the first and second panels being sealed together.

48. The product of claim 24, the food item comprising a sauce.

49. The product of claim 24, the food item comprising a combination of a sauce and a meat or meat-substitute product.

50. A microwaveable food product, comprising:
a self-venting pouch, the self-venting pouch having:
a first flexible panel,
a second flexible panel,
a plurality of flexible inset members, the base members extending between bottom sections of the first and second panels and upward into the pouch, the inset members and the first and second panels being outwardly expandable so that the bottoms of the panels form a base to support the pouch in an upright position, and
a rupturable seal formed in the first and second panels and along at least a portion of an aperture defined by the first and second panels; and
a food item contained within the pouch,
wherein at least a portion of the rupturable seal is broken to release steam generated by the heated food item within the pouch when the food item is sufficiently heated in the microwave oven.

51. A method of preparing a food item in a microwave oven, comprising:
inserting the food item within a flexible pouch;
sealing the pouch with the food item therein;
defining an aperture in the pouch; and
forming a rupturable seal in the pouch and along at least a portion of the aperture.

52. The method of claim 61, further comprising inserting the pouch containing the food item in the microwave oven;
sufficiently heating the food item in the microwave oven; and to break the rupturable seal, and releasing steam from the heated food item through the broken seal.
